(19) United States
(12) Patent Application Publication
(10) Pub. No.: US 2019/0384690 A1
(43) Pub. Date: Dec. 19, 2019

(54) METHOD FOR ESTIMATING MEMORY REUSE-DISTANCE PROFILE

(71) Applicant: College of William & Mary, Williamsburg, VA (US)

(72) Inventors: Xu Liu, Williamsburg, VA (US); Milind Mohan Chabbi, Cupertino, CA (US)

(21) Appl. No.: 16/440,405

(22) Filed: Jun. 13, 2019

Related U.S. Application Data
(60) Provisional application No. 62/684,287, filed on Jun. 13, 2018.

(51) Int. Cl. G06F 11/36

(52) U.S. Cl. CPC G06F 11/3612; G06F 11/3616

(57) ABSTRACT

A computer-implemented method estimates a memory reuse-distance profile for a program executing on a processing computer that includes a data memory, a hardware performance monitoring unit (PMU), and a debug register. During program execution, the PMU periodically samples accesses of the data memory. For each periodic access, a watchpoint in the debug register is armed for an address of the data memory associated with the corresponding periodic access wherein the debug register traps on a next access of the address. A total number of accesses to the data memory occurring between the periodic access and the next access of the address is determined. A stack reuse-distance histogram is generated using each of the total number of accesses determined as the program executes.

### CROSS-REFERENCE TO RELATED APPLICATIONS

Pursuant to 35 U.S.C. § 119, the benefit of priority from provisional application Ser. No. 62/684,287, with a filing date of Jun. 13, 2018, is claimed for this non-provisional application.

### STATEMENT REGARDING FEDERALLY SPONSORED RESEARCH AND DEVELOPMENT

This invention was made with government support under Grant No. 1618620 awarded by the National Science Foundation. The government has certain rights in the invention.

### FIELD OF INVENTION

The field of the invention relates generally to profiling of memory reuse-distance, and more particularly to a method for estimating a memory reuse-distance profile based on non-intrusive sampling of a data memory.

### BACKGROUND OF THE INVENTION

Memory access latencies remain orders of magnitude higher than cache access latencies both in traditional processing computers and accelerators. Accordingly, data locality has a profound impact on a program's execution performance such that programmers strive to maintain data locality during program execution.

In order to evaluate a program's memory access performance during program execution, programmers rely on a metric known as reuse distance. Reuse distance is a machine-independent, software metric generated during a program's execution that quantifies data locality. Briefly, reuse distance (also known as stack distance) is defined as the number of distinct memory elements accessed between the current memory access (reuse) and the previous memory access to the same memory element (use). For example, given a chain of memory accesses: a₁, b₁, c₁, b₂, a₂, where the subscripts represent the access number for the same memory location, the reuse distance for memory location a is 2 since two other memory locations b and c were accessed between consecutive accesses of memory location a. If the reuse distance of a memory location is larger than a processor's cache size, a capacity cache miss is guaranteed even in the absence of conflict misses. As is known in the art, a reuse distance profile is often presented as a histogram with bins representing different reuse distance ranges.

Collecting reuse distance for an entire program execution provides useful insights into a program's locality characteristics. Reuse distance data for a whole program enables various studies to include, for example, performance prediction, program phase prediction, processor caching and prefetching hints, profiling and code tuning, and power characterization. Given the importance of collecting reuse distance for a program's execution, a number of tools have been developed to provide reuse distances profiles (e.g., histograms) for entire program executions. However, existing reuse distance profiling tools utilize software instrumentation or the insertion of monitoring code into a program's execution code. Such tools instrument every load and store operation via a compiler or binary rewriter to obtain the effective memory address at program execution or runtime. Then, at runtime, an analysis routine logs the address to a stack data structure. Upon each memory access, these tools check the previous access to the same address and count the number of unique memory addresses touched in between to record an instance of reuse distance. On program termination when all the reuse instances have been captured, the reuse distance counts in different ranges of distances are aggregated and are binned into a histogram. Although these tools provide detailed information for analysis, their exhaustive instrumentation of the program and logging mechanisms increase program execution times by the hundreds and consume enormous amounts of extra memory, thereby preventing their use on long-running, production programs. While some attempts have been made to reduce the overhead associated with the collection of reuse distances, existing efforts still rely on software instrumentation with typical overheads remaining non-trivial or more than five times longer than a program's native execution time.

### BRIEF SUMMARY OF THE INVENTION

Accordingly, an object of the present invention is to provide a method for generating a reuse distance profile for a program execution.

Another object of the present invention is to provide a computer-implemented method for generating a reuse distance profile having very little impact on program execution runtimes and memory consumption.

In accordance with the present invention, a computer-implemented method for estimating a memory reuse-distance profile is provided for use on a processing computer that includes a data memory, a hardware performance monitoring unit (PMU), and a debug register. As a program executes on the processing system, the PMU periodically samples accesses of the data memory. For each of the periodic accesses of the data memory, a watchpoint in the debug register is armed for an address of the data memory associated with the corresponding one of the periodic accesses wherein the debug register traps on a next access of the address. A total number of accesses to the data memory occurring between the one of the periodic accesses and the next access of the address is determined. A stack reuse-distance histogram is generated using each of the total number of accesses determined when the program is executing.

### BRIEF DESCRIPTION OF THE DRAWINGS

The summary above, and the following detailed description, will be better understood in view of the drawings that depict details of preferred embodiments.

FIG. 1 is a schematic view of one type of conventional processing computer utilizing a single hardware debug register;

FIG. 2 is a schematic view of another type of conventional processing computer utilizing multiple hardware debug registers;

FIG. 3 is a flow diagram of the method for estimating a reuse distance profile in accordance with an embodiment of the present invention;

FIG. 4 is a timeline presentation of the hardware-based memory access sampling and monitoring scheme utilized in the present invention;

FIG. 5 is a flow diagram illustrating an embodiment of the present invention that includes measurement scaling in accordance with another embodiment of the present invention;

FIG. 6A is a stack use histogram for an execution code illustrating a real or ground truth histogram alongside the estimated histogram generated by the present invention; and

FIG. 6B is a stack use histogram for another execution code illustrating a real ground truth histogram alongside the estimated histogram generated by the present invention.

### DETAILED DESCRIPTION OF THE INVENTION

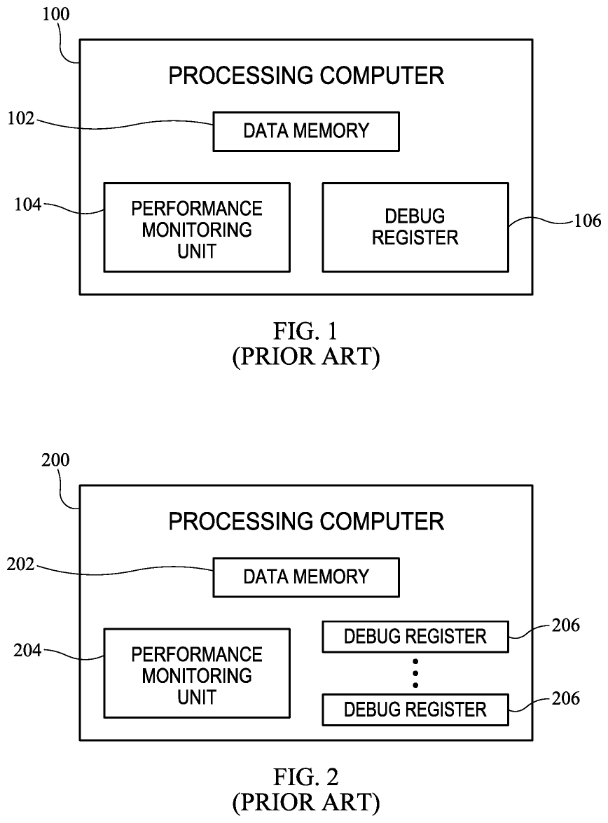

Prior to explaining the present invention, reference will be made to FIGS. 1 and 2 where two hardware configurations of processing computers are illustrated schematically. The only hardware elements shown in each configuration are those utilized by the present invention in the generation of a memory reuse distance profile for a program executing on the processing computer. Accordingly, and as would be understood by those skilled in the art, the processing computers will include additional hardware elements (not shown) used in a processing environment.

FIG. 1 illustrates a processing computer 100 (or CPU as it will also be referenced to herein) that includes an address-based data memory 102, a hardware performance monitoring unit 104, and a hardware debug register 106. FIG. 2 illustrates a processing computer 200 that includes an address-based memory 202, a hardware performance monitoring unit 204, and multiple hardware debug registers 206. As will be explained further below, the present invention can be utilized by either type of processing computer to generate a memory reuse distance profile in the form of a histogram, the analysis of which can then be performed by a programmer in an effort to make their program execute more efficiently. Brief descriptions of hardware performance monitoring units and hardware debug registers are presented immediately below.

A processing computer's hardware performance monitoring unit (PMU) is a hardware element that can be programmed to count hardware events such as loads, stores, CPU cycles, etc. PMUs can be configured to trigger an overflow interrupt on reaching a threshold number of events, the occurrence of which causes a sampling operation in the present invention. That is and as will be explained further below, the illustrated embodiment of the present invention's profiler runs in the address space of the monitored program, handles the PMU interrupt, and attributes the measurement “appropriately” to the execution context. However, the present invention is not so limited as the present invention's profiler could also be run in a separate address space (e.g., similar to a debugging routine) and use a separate method to control the main program. In either case, the PMU's ability to extract the effective data memory address being accessed at the PMU interrupt is also referred to as “address sampling”.

A processing computer's hardware debug register is a programmable element that enables trapping the processing computer's execution when the processing computer reaches an address (known as a breakpoint) or when an instruction accesses a designated memory address (known as a watchpoint). A watchpoint is a software abstraction of a debug register used to monitor data access. That is, a debug register monitors a particular address if a watchpoint is set or armed for that address. A watchpoint can be armed to trap on a write access or trap on a read access or a combination of two.

The present invention, by its sampling nature, greatly reduces processing time and memory overhead generally associated with collecting reuse distance measurements during a program's execution. In general, the present invention does not monitor every load and store during a program's execution in the generation of a reuse distance profile. Instead, the present invention utilizes a hardware-based sampling and monitoring scheme in the generation of an estimation of a reuse distance histogram that does not require a complete count of reuse distance instances. The present invention's effective sampling mechanism can be used to quantify the percentages of reuse instances falling in different reuse distance bins to thereby produce a reuse distance histogram that closely approximates a ground truth histogram.

The present invention samples memory accesses via the processing computer's PMU counter that has been configured to count memory access instructions and generate an interrupt on reaching a predefined threshold count/value. Then, on a PMU counter overflow (interrupt), the present invention obtains the address of the processing computer's data memory accessed at the PMU interrupt to thereby define the use point. To detect the reuse point (i.e., the immediate next access to the same memory element), the present invention arms a watchpoint for the same effective address in the processing computer's hardware debug register and lets the program continue its normal execution. When the program accesses the same address location again, the debug register's watchpoint traps. The number of memory accesses elapsed between the use and reuse points are counted (i.e., a time distance). The number of memory accesses elapsed between a sample and the corresponding watchpoint trap can be readily determined by running a memory access counter and knowing its value at two points in time and subtracting the earlier one from the later. Such profiling continues throughout the program's execution in order to collect a plurality of reuse instances along with their time distance. Finally, the sampled time distance profiles are converted into stack reuse distance profiles following a well-known technique. Since the present invention uses the processing computer's PMU for address sampling and the processing computer's debug registers for address monitoring, there is no need to instrument the program's execution code or perform use-reuse analysis on every memory access. As a result, overhead is incurred only in the PMU sample interrupt handler and debug register trap handler.

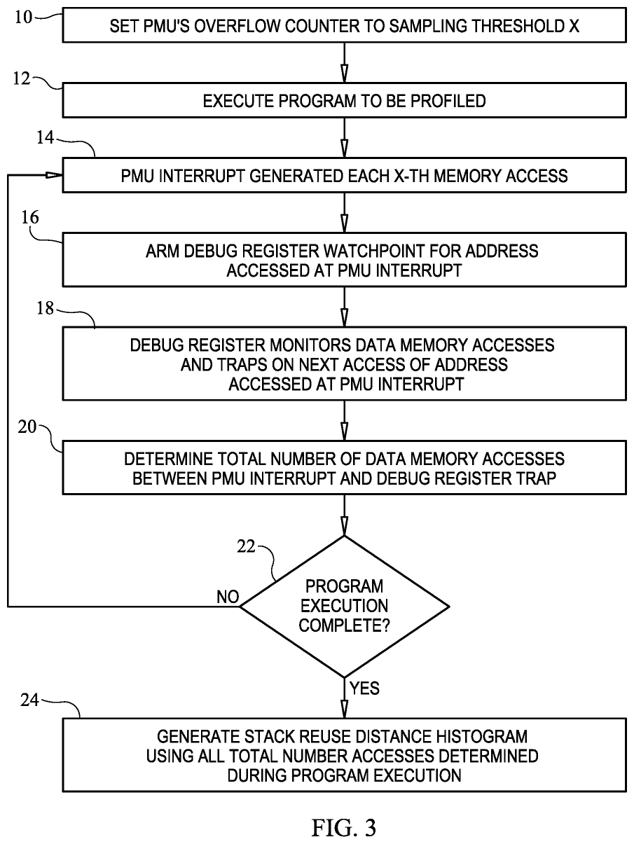

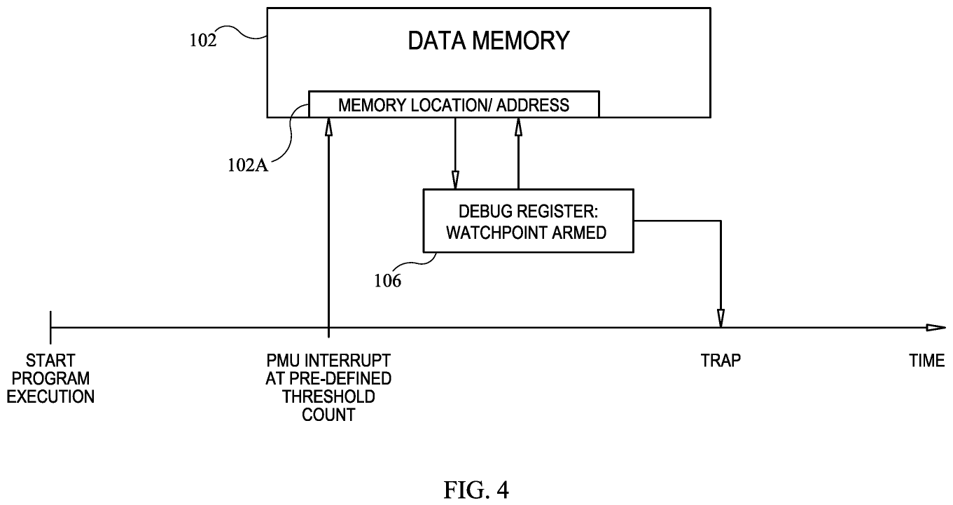

Referring again to the drawings, simultaneous reference will be made to FIGS. 3 and 4, in order to explain the novel features of the present invention. FIG. 3 is a flow diagram of the present invention's basic process steps, and FIG. 4 illustrates a timeline presentation of the hardware-based memory access sampling and monitoring scheme utilized in the present invention. Additional features of the present invention will be described later herein.

The process of the present invention is a computer-implemented method that runs on a processing computer such as computers 100 and 200 described above. The installation of the present invention on a processing computer and the execution thereof on the processing computer are well-understood in the art and will not be explained further herein. The process begins at step 10 where the processing computer's PMU has its overflow counter set to trigger an interrupt at a predefined threshold count X where the PMU's counter increments for each access of the processing computer's data memory such as data memory 102 (FIG. 4). The count X can remain the same for the entire execution or be dynamically changed without departing from the scope of the present invention. The program to be profiled starts its execution at step 12. Each time the X-th memory access occurs as counted by the PMU, the PMU generates an interrupt at step 14. At step 16, the memory address 102A accessed at the X-th PMU-generated interrupt (or use point) is used to arm a watchpoint for the accessed memory address in debug register 106. At step 18, the armed debug register monitors accesses to data memory 102 and traps on the next access to memory address 102A. Next, at step 20, the present invention determines the total number of data accesses of data memory 102 occurring between the PMU interrupt and trap for the memory address 102A that is the subject of the watchpoint for the armed debug register 106. The total number of data accesses is also referred to as a time distance measurement. If the program is still executing, decision step 22 returns and awaits the next PMU interrupt occurring at the next X-th memory access indicated at step 14. At the conclusion of a program's execution, all of the time distance measurements generated by steps 14-20 are used at step 24 to generate a stack reuse distance histogram. The conversion of time reuse distance measurements to a stack reuse histogram is disclosed by Shen et al. in “Locality approximation using time,” Proc. Of the 34^{th} Annual ACM SIGPLAN-SIGACT Symposium on Principals of Programming Language, 2007, the entire contents of which is hereby incorporated by reference.

Since the number of hardware debug registers available for use in a typical processing computer is limited (i.e., ranging from 1 to less than 10), the present invention can also implement procedures to cope with this hardware limitation. For example, at the very least, a debug register's watchpoint is disarmed after the trap occurring at step 18 thereby freeing up the debug register for subsequent arming with a new watchpoint at the next successive PMU interrupt. More generally, the limited number of debug registers necessitates additional processing to accommodate the fact that hardware can monitor only a relatively small number of addresses at a time as compared to the number of memory accesses occurring during a program execution. Further, the fact that use and reuse accesses to the same memory location are often separated by many PMU samples (or long distance reuses as they are known) complicates matters. To help explain this issue, consider the following reuse examples based on the listing below. The issue will first be explained for a processing computer having one debug register and then for a processing computer having 4 hardware debug registers. For purposes of these examples, assume the processing computer's PMU is set to sample/interrupt at every 10K memory accesses.

1 for(int i = 1; i <= 100K; i++){
2 t += array[i];
3 }
4 for(int j = 1; j <= 100K; j++){
5 m += array[j];
6 }

Assume the loop index variables i, j, and the scalar t and m are in registers, the sampling period is 10K memory accesses, and the number of debug registers is one. The first sample happens in the i loop when accessing array[10K]. As explained above, the present invention arms a watchpoint to monitor &array[10K] since a debug register is available. The second sample happens when accessing array[20K]. However, since the watchpoint armed for address &array[10K] is still active, there is no room to monitor &array[20K]. Naively, one may replace the previously armed watchpoint (&array[10K]) with &array[20K]. However, this approach does not detect any reuse in the code. When the j loop starts executing, the only active watchpoint will be the last sampled address &array[100K] in the i loop. The PMU keeps delivering samples in the j loop as well. At j=10K, the last watchpoint &array[100K] will be replaced with &array[10K], which will not be accessed again. Accordingly, at the end of the j loop, not a single watchpoint would have triggered and hence no reuse would be detected.

Monitoring a new sample may help detect a new, previously unseen reuse whereas continuing to monitor an old, already-armed address may help detect a reuse separated by many intervening operations. While the goal is to detect both, one cannot predict when in the future a watchpoint may trap, if at all. A slightly smarter strategy is to flip a coin to decide whether or not to arm a watchpoint for the newest sample. Unfortunately, this strategy also fails because the survival probability of an older sample is minuscule if the distance between consecutive accesses to the same memory location is significantly larger than the sample period.

For the processing computer having 4 debug registers, the above example begins differently but ultimately experiences the same issue as the single debug register case. That is, in the 4 debug register example, all watchpoints will be armed when sampling at 10K memory accesses in the first four samples taken in the i loop. A naive replacement will not trigger a single watchpoint due to many samples taken in the i loop before reaching the j loop. As will be explained further below, the present invention ensures that each sample has an equal probability to survive.

The present invention applies a survival or replacement probability approach that incorporates a modification to the well-known reservoir sampling technique. In general, a reservoir sampling approach to survival probability strikes a balance between new vs. old by choosing among the previously accessed addresses without any bias. Details of conventional reservoir sampling are disclosed by Vitter in “Random Sampling with a Reservoir,” ACM Trans. Math. Softw., vol. 11, no. 1, March 1985. [Online]. Available: http://doi.acm.org/10. 1145/3147.3165, and Wen et al. in “Watching for software inefficiencies with which,” Proceedings of the Twenty-Third International Conference on Architectural Support for Programming Languages and Operating Systems, ser. ASPLOS '18, 2018 [Online] Available: http://doi.acm.org/10.1145/3173162.3177159, the entire contents of which are hereby incorporated by reference.

In accordance with conventional reservoir sampling, a first sampled address, M₁, occupies the debug register with 1.0 probability. A second sampled address, M₂, overwrites the previously armed watchpoint with 1/2 probability and retains the old one with 1/2 probability. A third sampled address, M₃, over-writes the previously armed watchpoint with 1/3 probability and retains old one (either M₁ or M₂) with 2/3 probability. The kth sampled address Mk since the last time a debug register was empty, replaces the previously armed watchpoint with 1/k probability. At the end of the kth sample, the probability of monitoring any sampled address M₁, 1≤i≤(k) addresses is the same. The scheme trivially extends to more than one debug register as described by the above-referenced Wen et al. disclosure.

In the present invention and as mentioned above, any time a watchpoint traps, the armed watchpoint is disarmed. The present invention also resets the debug register's reservoir probability to 1.0 to indicate the debug register is available for arming. Obviously, if every watchpoint triggers before the next sample, every address seen in every sample would be monitored. Since there are so few debug registers as compared to memory accesses, this scenario is just not possible leading to the employment of a survival or replacement probability scheme in the watchpoint arming process. However, the above-described conventional reservoir sampling leads to a disproportionate attribution based on whether a subset of sampled addresses are monitored (when the reservoir is full at the sample point) or all sampled addresses are monitored (reservoir is not full at the sample point).

To correct the disproportionate attribution problem associated with conventional reservoir sampling, the present invention uses a context-sensitive scaling scheme disclosed in the above-cited Wen et al. reference to correct this attribution problem. Briefly, the context-sensitive scaling scheme uses the heuristic that code behavior is typically the same in a calling context. Based on this heuristic, if N PMU samples were taken in a calling context C, of which only one was used to arm a watchpoint when such watchpoint traps, and if the reuse distance is measured to be D, the present invention scales the number instances of reuses of distance D to be N.

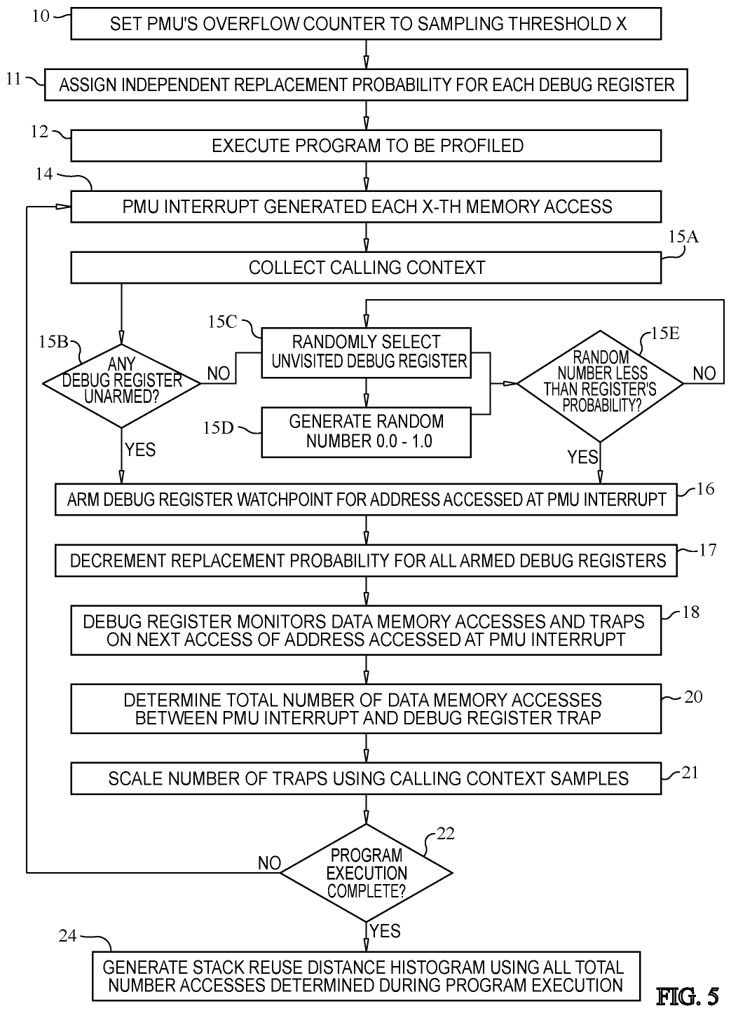

Since most processing computers include multiple hardware debug registers, the present invention's handling of survival or replacement probability will be explained for the multiple debug register scenario. Reference will now be made to FIG. 5 where the present invention's method is added to and expanded for the handling of replacement probability for each debug register during a program execution. Each debug register's replacement probability is an independently set probability.

Initially and as shown at step 11, the present invention assigns each debug register to have a replacement probability of 1.0 indicative of the fact that each debug register's watchpoint is disarmed. Then, as previously described, the program to be profiled commences execution at step 12 and PMU interrupts are generated at step 14. As part of the present invention's measurement scaling, step 15A collects the calling context associated with the program's execution code at the PMU interrupt. As is well-known in the art, the calling context refers to the variables and directives in the execution context of where it is called. Decision step 15B identifies if there is an unarmed debug register or the one with replacement probability of 1.0. If so, the debug register is armed in step 16 and the process proceeds to step 17. If there is no unarmed debug register, steps 15C, 15D and 15E iterate over the available hardware debug registers. Step 15C randomly selects an unvisited debug register. Step 15D generates a random number between 0-1.0, and step 15E compares the random number to the replacement probability associated with the debug register chosen in step 15C. If the random number is less that the replacement probability of the chosen debug register, the process proceeds to step 16 to re-configure such debug register with the new address seen in the interrupt. If the random number is greater than the replacement probability in step 15D, the search continues at step 15C. Whether replaced or not, the surviving debug register's replacement probability is reduced in step 17 and the execution continues. Next time the same address is accessed by the program, the debug register traps in step 18. Step 20 determines the number of memory accesses, say M, elapsed between step 14 and 20. Step 21 bins this into a histogram based on the value of M. However, since some interrupts may never be monitor, step 21 scales the number of entries (i.e., traps) added to the histogram based on the number of samples taken in the calling context at step 15A.

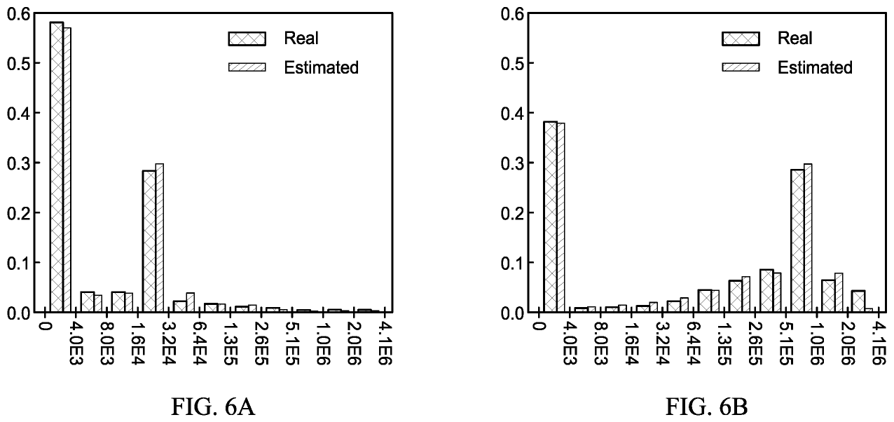

The advantages of the present invention are numerous. The present invention is a low-overhead, sampling-based tool for characterizing program data locality by the generation of a stack reuse distance histogram. However, the present invention requires no instrumentation and therefore, avoids the overhead associated therewith. Instead, the present invention combines the address-sampling capability of hardware performance units with hardware debug registers to sample reuse pairs during program execution. Further, the present invention uses reservoir sampling and proportional attribution to avoid hardware limitations and sampling bias. As shown in FIGS. 6A and 6B, the present invention yields comparable accuracy as compared to real or ground truth histograms obtained via exhaustive conventional tools relying on instrumentation, but only incurs 5% runtime and 7% memory overheads.

### INCORPORATION BY REFERENCE

All publications, patents, and patent applications cited herein are hereby expressly incorporated by reference in their entirety and for all purposes to the same extent as if each was so individually denoted.

### EQUIVALENTS

While specific embodiments of the subject invention have been discussed, the above specification is illustrative and not restrictive. Many variations of the invention will become apparent to those skilled in the art upon review of this specification. The full scope of the invention should be determined by reference to the claims, along with their full scope of equivalents, and the specification, along with such variations.

We claim:

1. A computer-implemented method for estimating a memory reuse-distance profile, comprising the steps of:
providing a processing computer that includes a data memory, a hardware performance monitoring unit (PMU), and a debug register;
executing a program on the processing system;
sampling, using the PMU, periodic accesses of the data memory during said step of executing;
arming, for each of said periodic accesses of the data memory, a watchpoint in the debug register for an address of the data memory associated with a corresponding one of said periodic accesses wherein the debug register traps on a next access of the address;
determining a total number of accesses to the data memory occurring between said one of said periodic accesses and the next access of the address; and
generating a stack reuse-distance histogram using each of the total number of accesses determined when the program is executing.

2. A computer-implemented method according to claim 1, further comprising the step of disarming the watchpoint in the debug register after the debug register traps on the next access of the address.

3. A computer-implemented method according to claim 1, wherein the processing computer includes N debug registers wherein N>1, said method further comprising the steps of:
assigning an independent replacement probability to each of the N debug registers; and
modifying the independent replacement probability for the N debug registers following each of said periodic accesses.

4. A computer-implemented method according to claim 1, wherein the processing computer includes N debug registers wherein N>1, said method further comprising the steps of:
assigning an independent replacement probability to each of the N debug registers;
disarming the watchpoint in one of the N debug registers after said one of the N debug registers traps on the next access of the address;
setting the independent replacement probability to 1.0 for said one of the N debug registers whose watchpoint is disarmed by said step of disarming; and
decrementing the independent replacement probability for each of the N debug registers whose watchpoint was not disarmed by said step of disarming.

5. A computer-implemented method for estimating a memory reuse-distance profile, comprising the steps of:
providing a processing computer that includes a data memory, a hardware performance monitoring unit (PMU) having an overflow counter set to trigger an interrupt at a predefined count, and a plurality of debug registers;
executing a program on the processing system wherein the PMU increments the overflow counter for each access of the data memory occurring during said step of executing;
generating a first interrupt at the PMU each time the overflow counter increments to the predefined count, wherein a watchpoint is armed in one of the debug registers for an address of the data memory associated with the access thereof;
generating a second interrupt at said one of the debug registers for a next access of the data memory at said address associated with the watchpoint;
determining a total number of accesses to the data memory occurring between said first interrupt and said second interrupt; and
generating a stack reuse-distance histogram using each of the total number of accesses determined when the program is executing.

6. A computer-implemented method according to claim 5, further comprising the step of disarming the watchpoint in said one of the debug registers after said second interrupt is generated.

7. A computer-implemented method according to claim 5, further comprising the steps of:
assigning an independent replacement probability to each of the debug registers; and
modifying the independent replacement probability for the debug registers following each said first interrupt.

8. A computer-implemented method according to claim 5, further comprising the steps of:
assigning an independent replacement probability to each of the debug registers;
disarming the watchpoint in said one of the debug registers after said second interrupt is generated;
setting the independent replacement probability to 1.0 for said one of the debug registers whose watchpoint is disarmed; and
decrementing the independent replacement probability for each of the debug registers whose watchpoint was not disarmed.

9. A computer-implemented method for estimating a memory reuse-distance profile, comprising the steps of:
providing a processing computer that includes a data memory, a hardware performance monitoring unit (PMU), and a plurality of debug registers;
executing a program on the processing system;
generating use interrupts using the PMU for each periodic access of the data memory during said step of executing, wherein a watchpoint is armed in one of the debug registers for an address of the data memory associated with the access thereof;
generating a reuse interrupt at said one of the debug registers for a next access of the data memory at said address associated with the watchpoint;
determining a total number of accesses to the data memory occurring between said use interrupt and said reuse interrupt; and
generating a stack reuse-distance histogram using each of the total number of accesses determined when the program is executing.

10. A computer-implemented method according to claim 9, further comprising the step of disarming the watchpoint in said one of the debug registers after said reuse interrupt is generated.

11. A computer-implemented method according to claim 9, further comprising the steps of:
assigning an independent replacement probability to each of the debug registers; and
modifying the independent replacement probability for the debug registers following each said use interrupt.

12. A computer-implemented method according to claim 9, further comprising the steps of:
assigning an independent replacement probability to each of the debug registers;
disarming the watchpoint in said one of the debug registers after said reuse interrupt is generated;
setting the independent replacement probability to 1.0 for said one of the debug registers whose watchpoint is disarmed; and
decrementing the independent replacement probability for each of the debug registers whose watchpoint was not disarmed.
